(19) United States
(12) Patent Application Publication
(10) Pub. No.: US 2006/0196998 A1
(43) Pub. Date: Sep. 7, 2006

(54) Multimedia display system

(76) Inventor: Salvatore Matteo, Los Angeles, CA (US)

Correspondence Address: FULWIDER PATTON, 6060 CENTER DRIVE, 10TH FLOOR, LOS ANGELES, CA, 90045, US

(21) Appl. No.: 11/321,614

(22) Filed: Dec. 28, 2005

Related U.S. Application Data
(60) Provisional application No. 60/644,632, filed on Jan. 18, 2005.

(51) Int. Cl. F16M 11/04

(52) U.S. Cl. 248/176.3; 248/921

(57) ABSTRACT

A multimedia display system for displaying visual or audio visual media is provided. The system has a base and a rigid stand connected to the base. The stand has at least one support member that forms an acute angle with the base. An articulated arm is operatively connected to the stand and an attachment device connected to the articulated arm for attaching modules that display media.

### CROSS-REFERENCES TO RELATED APPLICATIONS

This application claims the benefit of U.S. Provisional Patent Application No. 60/644,632, filed Jan. 18, 2005, incorporated herein by reference.

### BACKGROUND OF THE INVENTION

The subject invention generally relates to support devices for printed material and digital multimedia devices, including book holders and computer electronic display device supports. While viewing media, whether printed or otherwise, the viewer may be required to maintain an uncomfortable position for long periods of time that can result pain or injury to the neck or other critical joints. Therefore, there is a need for a display system that provides mobility and adjustability to the visual media being displayed.

The invention addresses the need for support of printed and electronic media (for example, eBooks, flat-screen electronic display devices) placed on planar surfaces suspended from an articulated arm that mounts to a mobile stand, walls, furniture and or mobility-assist devices (including wheelchairs and scooters), and that affords adjustable inclination and rotation to the planar support device.

The act of reading is an internationally popular means of recreation, education and information gathering for people of all ages and socio-economic groups. Although the medium of the reading material has changed dramatically in the technological landscape of the 21st Century, the act of reading remains unchanged and one of the most pleasurable aspects of reading continues to be while relaxing in the seated position or reclining.

Unfortunately, reclined and seated reading may cause neck, back and shoulder pain and can lead to muscle fatigue. The reader's body must flex and strain neck, shoulder, forearm, hand and back muscles in order to maintain the reader's head and angle of vision, or in order to hold the reading material in an upright direction in line with one's angle of vision. Without assistance, reading in a relaxed supine or seated position yields awkward, fatiguing and sometimes painful body positions which dramatically reduce the duration, comfort and pleasure of reading while sitting or lying down.

Reading electronic display devices also results in awkward, fatiguing and sometimes painful body positions. Sitting at desks and viewing poorly situated monitors for extended periods are increasingly cited as the causes for poor posture, muscle strain and body fatigue. Computer monitors are generally not designed for viewing while reclined without the assistance of unwieldy and expensive devices. Most electronic display assistance devices are constructed to assist users seated at desk furniture rather than for a person lying down or seated independent of desk furniture, such as sitting in a wheelchair.

In addition, there is a need for mobile computer systems or multimedia display systems in a commercial environment that are functional, yet minimalist in design. Also, in the pursuit of attracting the attention of the consumer in the market place, there is a need for a system that communicates audiovisual information that is both maneuverable and whimsical or festive in appearance. The present invention meets these and other needs.

### SUMMARY OF THE INVENTION

The invention features a combination of modular components in order to expand the device's use with both print and digital material. The invention also expands the applicability of such devices to mobility assist devices such as wheelchairs.

The invention may be attached to fixtures including walls, beds and desk furniture to provide support for reading material. A universal plate is disclosed that, along with the rest of the display system, secures, suspends and supports books, as well as electronic display devices, in order to reduce the physical fatigue of holding the book or electronic device while viewing, scanning or reading the contents.

In an aspect of the invention, a multimedia display system for displaying visual or audio visual media is provided. The system has a base and a rigid stand connected to the base. The stand has at least one support member that forms an acute angle with the base. An articulated arm is provided and is connected to the stand. An attachment device is connected to the articulated arm for attaching modules that display media.

In another aspect, the multimedia display system has a base with a central portion and a periphery portion, a rigid stand having a top, a bottom and at least one support member connected between the top and bottom. The support member is connected to at least a part of the periphery portion of the base and the top is located over at least a part of the central portion of the base. An articulated arm connected to the stand is provided, and an attachment device is provided that is removably connected to the articulated arm for attaching modules that display media.

In yet another aspect of the invention, a multimedia display system for displaying visual or audio visual media is provided. The system has a base and a rigid stand connected to the base. The stand has at least one support member that forms an acute angle with the base. An articulated arm is provided and is operatively connected to the stand. A platform is positioned between the stand and the articulated arm. The platform has a first area and a substantially flat surface. An attachment device is connected to the articulated arm for attaching modules that display media.

In still another aspect, the multimedia display system has an arm yolk connected to the top of the stand, and the articulated arm is seated within the arm yolk and is rotatable within the arm yolk.

In yet another aspect, the platform has at least one passageway.

In still another aspect, the multimedia display system has a mount for holding a camera, and the mount is connected to the attachment device.

In yet another aspect, the multimedia display system has a view screen secured to the attachment device, a keyboard, and a computer.

In another aspect, the multimedia display system has a wire harness for conducting wires located adjacent to the stand, and the articulated arm.

In still another aspect, the multimedia display system has a clip for attaching visuals. The clip is connected to the articulated arm.

In yet another aspect, the stand defines a case that houses a computer system.

In another aspect, the multimedia display system has a rechargeable battery connected to the base.

In still another aspect, the multimedia display system has at least two wheels connected to the base and a remote control motor attached to the base for providing locomotive power to the display system. A global positioning system is provided for sending and receiving coordinates relating to the location of the display system.

In yet another aspect, the multimedia display system has a sleeve with two opposite open ends for envelopment of the articulated arm and the stand. The sleeve may have animal skin indicia printed thereon to give the system the general appearance of the body of an animal. The sleeve my have trademark indicia printed thereon or the sleeve may have flexible protrusions thereon.

In another aspect, the module for displaying media is a book support platform comprising two hook and loop straps (for example, formed from Velcro) for securing a book to the module and two clips for maintaining the book at a particular page.

In still another aspect, the attachment device has a planar surface with at least four passageways for permitting a fastener to connect to the module through the passageway in order to secure the module to the display system.

In yet another aspect, the base has a cavity with a sealable opening.

In another aspect, the multimedia display system has a base and a rigid stand, having a top, a bottom, and at least one angled support member connected between the top and bottom that forms an acute angle with the base. An articulated arm is operatively connected to the stand and has an attachment device connected to the articulated arm for attaching modules that display media.

In still another aspect, the multimedia display system has a base, at least two wheels connected to the base. A rigid stand is connected to the base and has at least one support member that forms an acute angle with the base. An arm yolk is connected to the top of the stand and an articulated arm is operatively connected to the arm yolk and rotatable within the arm yolk. An attachment device is connected to the articulated arm for attaching modules that display media. The attachment device including fasteners and a planar surface with at least four passageways for permitting the fasteners to connect to a module through the passageways in order to secure the module to the display system.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a perspective view, depicting a multimedia display system of the present invention;

FIG. 2 is a perspective view, depicting a base and a stand of the multimedia display system shown in FIG. 1;

FIG. 3 is a perspective view, depicting the base and the stand;

FIG. 4 is a perspective view of a bottom of the base shown in FIG. 2;

FIG. 5 is a perspective view, depicting a base and a cavity;

FIG. 6. is a perspective view of the base and an accessory;

FIG. 7 is a perspective view, depicting a mount for holding a camera;

FIG. 8 is a perspective view of the multimedia display system, depicting the range of motion of the system;

FIG. 9 is a perspective view of an articulated arm of the multimedia display system of FIG. 1;

FIG. 10 is a perspective view, depicting an attachment device;

FIG. 11 is a perspective view of the system supporting a flat panel monitor;

FIG. 12 is a perspective view of a module that supports print media;

FIG. 13 is a perspective view of the back of the module that supports print media;

FIG. 14 is a perspective view of the multimedia display system, depicting a mounting bracket and a projector;

FIG. 15 is a perspective view of the multimedia display system, depicting a wire harness;

FIG. 16 is a perspective view of the multimedia display system, depicting the system with a wheelchair;

FIG. 17 is an enlarged view, depicting a bracket attached to the wheelchair;

FIG. 18 is a perspective view of the multimedia display system, depicting a platform;

FIG. 19 is an exploded view of the multimedia display system of FIG. 18;

FIG. 20 is a perspective view of the multimedia display system, depicting a means for attaching visuals;

FIG. 21 is a perspective view of the multimedia display system, depicting a base and stand housing a computer system;

FIG. 22 is a perspective view of the base and side of the stand housing a computer system of FIG. 21;

FIG. 23 is a perspective view of the base and back side of the stand housing a computer system of FIG. 21;

FIG. 24 is a perspective view of the bottom of the base, depicting a motor and GPS;

FIG. 25 is a perspective view of the multimedia display system, depicting a sleeve having flexible protrusions;

FIG. 26 is a perspective view of the multimedia display system, depicting a sleeve that has trademarks printed thereon; and

FIG. 27 is a perspective view of the multimedia display system, depicting a sleeve having indicia of the skin of an animal.

### DETAILED DESCRIPTION OF THE PREFERRED EMBODIMENTS

Referring to the drawings, which are provided for purposes of illustration and by way of example, the present invention provides a multimedia display system 10 for displaying visual or audio visual media. Media may be any method of communication such as, but not limited to, print in books, magazines or newspapers, as well as audio visual communication such as, but not limited to, films, video, computer graphics, and audio and the like.

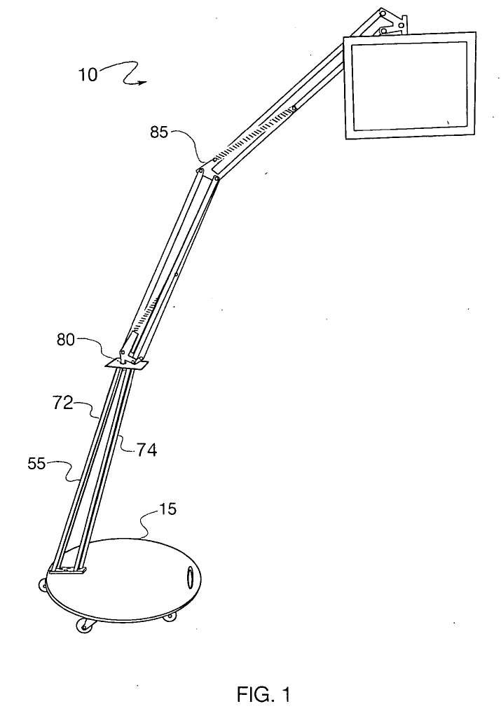

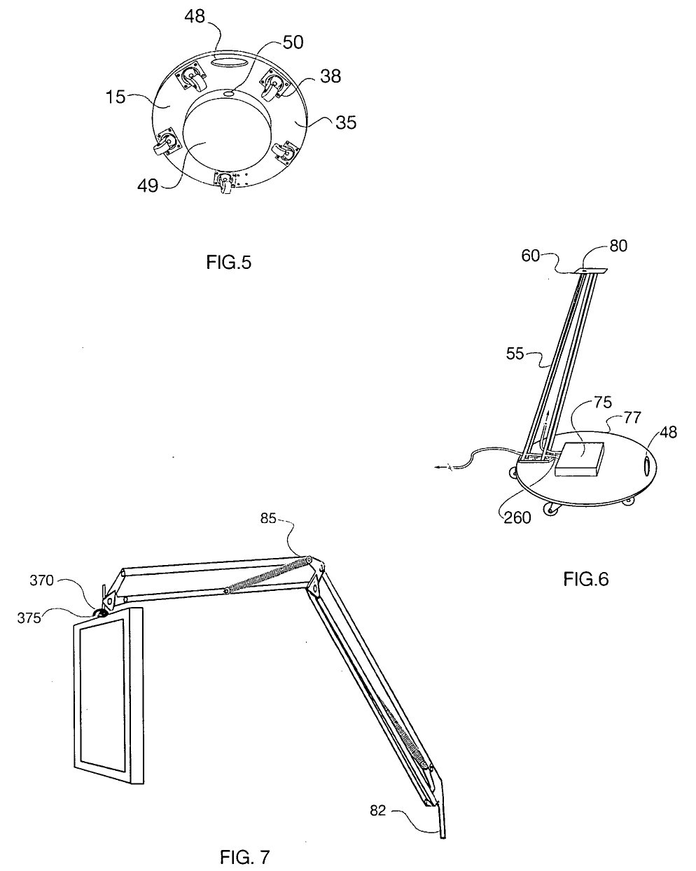

In one aspect of the invention, as shown in FIGS. 1-9, a base 15 is provided which may be circular in shape and generally in the form of a disc with a substantially flat surface 25 on which objects may be placed. Other shapes may include various combinations of curves and polygons (not depicted), such as a triangle, square, or rectangle, depending on the application. For example, one might prefer a base 15 with a circular perimeter 30 to avoid the presence of sharp corners that may cause injury. On an underside 35 of the base 15, four wheels 38 are attached for ease in moving the system 10. The base 15 also includes a periphery 40 and central 45 portions. The base 15 may be made of plastic or various metals or metal alloys such as iron or steel, for example. The base 15 further includes a cutout 48 that serves has a grip.

In another aspect, as shown in FIG. 5, the base 15 is made of plastic and further includes a cavity 49 with a sealable opening 50 in the underside 35 for filling the cavity with a suitable material, such as sand, cement, or water, to increase the weight of the base. The empty plastic base 15 facilitates transport by being lighter in weight, and can be easily filled by the consumer with any pourable material.

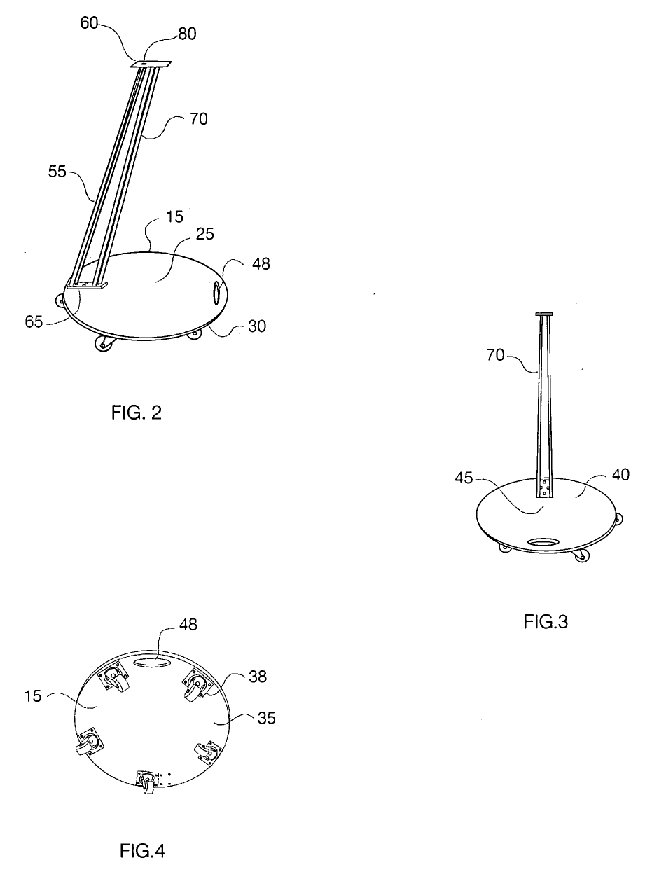

Referring to FIGS. 1 and 2, situated on the substantially flat surface 25 of the base 15 is a rigid stand 55. The stand 55 has a top 60, a bottom 65, and four support members 70 connected to the base 15. Each support member 70 may be formed from a rod having a diameter in the range from about 0.1 inches (2.54 millimeters) to about 0.5 inches (12.7 millimeters) and preferably about 0.25 inches (6.35 millimeters). The rods may be formed from metals, alloys, and synthetic materials, such as, steel, aluminum, and polycarbonate. The support members 70 have a pair of outer members 72 and a pair of inner members 74. The stand 55 is attached to the base 15 at the periphery portion 40 of the base 15 and is preferably acutely angled over the central portion 45, whereby the outer members 72 form an angle with the base 15 (for example, in the range of forty-five to ninety degrees, and preferably seventy degrees) and the inner members 74 form an angle with the base 15 (for example in the range of forty-five to ninety degrees, and preferably eighty degrees). Several advantages follow from this configuration. The flat surface 25 of the base 15 is generally free from obstruction for the placement of accessories 75, such as a personal computer 77, to the display system 10. The angled nature of the stand 55 tends to place the center of mass of the system 10 over the central portion 45 of the base to add greater stability to the system 10.

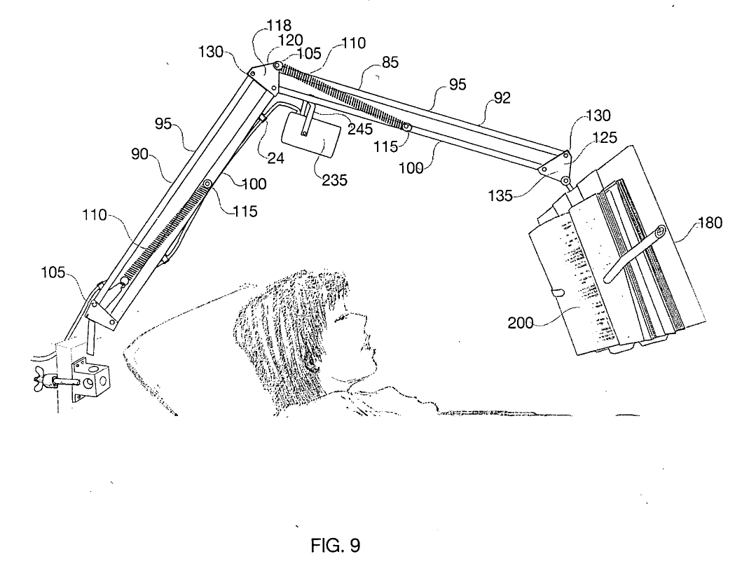

At the top 60 of the stand 55 is located an arm yolk 80. The yolk 80 is configured to receive a shaft 82 of an articulated arm 85 (also known as a jointed arm 85), to connect the arm 85 to the stand 55. As shown in FIG. 9, the shaft 82 may rotate within the yolk 80 about an axis 88 perpendicular to the flat surface 25 of the base 15 to permit rotation of the articulated arm 85 through a 360 degree angle. The shaft 82, and consequently the arm 85, is removable from the yolk 80. The articulated arm 85 is composed of two shorter segments 90, 92 each made of a pair of upper 95 and lower 100 lever arms. At a pivoting end 105 of the segments 90, a pair of springs 110 are attached to an upper lever arm 95 of the segments 90 and extend to approximately the midpoint 115 of a lower lever arm 100.

The lever arms 95, 100 of a first segment 90 of the arm 85 are pivotable about shaft 82 and at an opposite end 118 the first segment 90 is provided with a lockable connector assembly 120. A second segment 92 is similar in construction to the first segment 90. The second segment 92 is provided with a second lockable connector assembly 125, lever arms 95, 100 and a pair of springs 110.

The second segment 92 of the articulated arm 85 is pivotally connected with the first segment 90 through assembly 120. The assemblies 120, 125 comprise a series of nuts and bolt pairs 130 that can be tightened into position or loosened to promote ease of movement. This construction allows for the segments 90, 92 to pivot with respect to one another in either a clockwise or counter-clockwise direction.

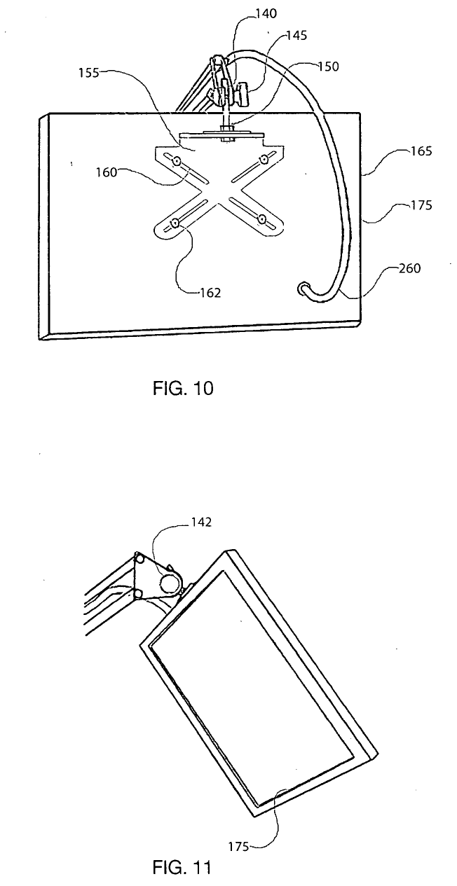

Turning now to FIGS. 10-12, attached to an end 135 of the second segment 92 is a bracket 140. The bracket 140 is connected to the segment 92 by a bolt 142 and wing nut 145. The bracket 140 receives a second shaft 150 whereby when the wing nut 145 is tightened, the shaft 140 is fixed in position. The second shaft 150 is rotatable about its axis through a 360 degree angle within the bracket 140. The shaft 140 may also rotate about the axis of the bolt 142. The second shaft 150 connects to an attachment device 155 that attaches to a module 165. Thus, the display system 10 described herein has the advantage of permitting a user to move the arm 85 in any one of a number of directions to either alter the angle of inclination of the module 165 or to move the module 165 toward or away from the viewer without varying the angle of inclination of the module 165. Further, the attachment device 155 is removable from the system 10.

The attachment device 155 is planar and contains four linear channels 160 oriented in the general shape of an incomplete X, for passage of fasteners 162, such as bolts or screws, for attaching a module 165 that displays various media. The relative angles of the channels 160 with respect to one another may be determined by the industry standards of the modules' 165 bolt pattern. For example, the module 165 may comprise a flat panel monitor 175 or a support member 180 that supports print media such as a book. For flat panel monitors under 23 inches, they may have a bolt pattern that is VESA (Video Electronics Standards Association) mounting compliant, in which case the diagonal channels will have appropriate orientations to permit attachment of a bolt pattern in a seventy-five millimeter (mm) by seventy five mm square or one hundred mm by one hundred mm square. Because of the ease by which a user may loosen the wing nut 145 and remove the second shaft 150, the display system 10 has the advantage of being readily capable of combining with various different modules 165, by removing the attachment device 155 from the system 10.

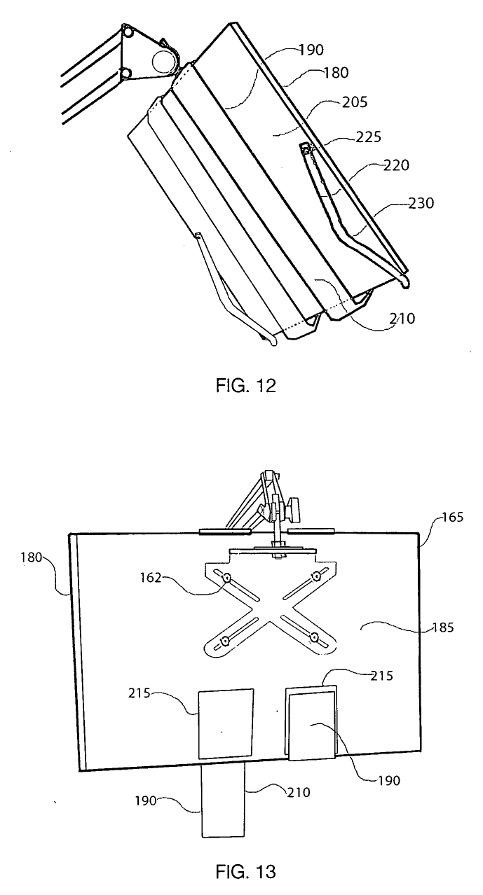

Turning now to FIGS. 12-13, the attachment device 155 attaches to a back 185 of the module 165 that supports print media 180 and secured with screws 162. Straps 190 are fastened to an upper portion of the module 180 and secure an article of print media 200 to a platform 205 when hook and loop (also known as Velcro) ends 210 of the straps 190 attach to the back 185 of the module at receiving Velcro pads 215.

The print media module 180 has page retainers 220 fastened to the platform 205 via screws 225. The retainers 220 serve to keep an article of print media 200 open to a particular page. In one aspect, the retainers 220 are composed of a suitable material for being flexible and capable of bending. In another aspect, the retainers 220 are metallic and contain a single bend 230 along their length and can rotate about their point of attachment 225.

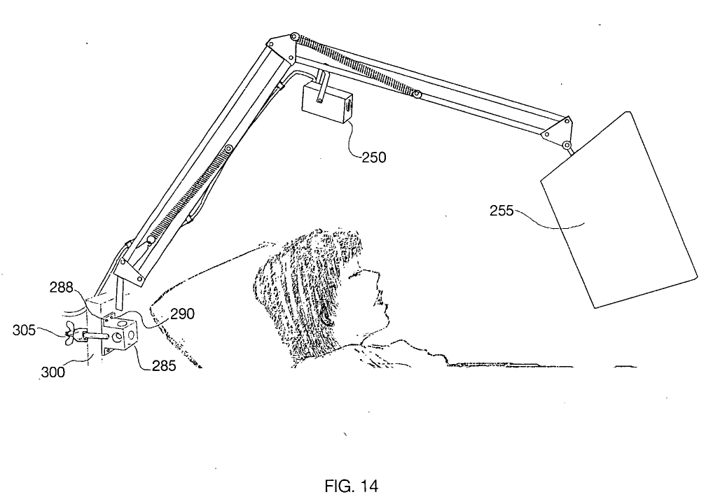

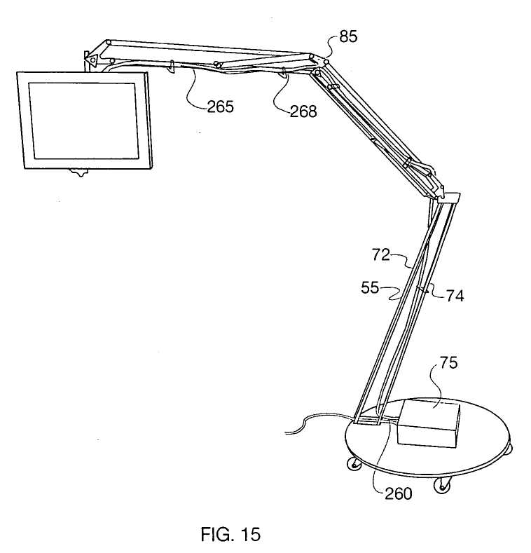

In another aspect, as shown in FIG. 9, a lamp 235 may be connected to the second segment 92 of the arm 85 and is rotatable about its mounting bracket 245. A beam of illumination from the lamp 235 may be directed at the module 165 or can be used for illuminating other items in a room when the module 165 is removed from the system 10. In another aspect, as shown in FIGS. 14 and 15, a projector 250 may be mounted to on the arm 85 for display of visual media on a screen module 255, when connected to the system 10. Cables 260 for the various devices are conducted by means of a wire harness 265 that is located adjacent to and within the stand 55 and arm 85 and is attached to the system with appropriate fasteners 268 such as cable clamps or clips as shown in FIG. 15.

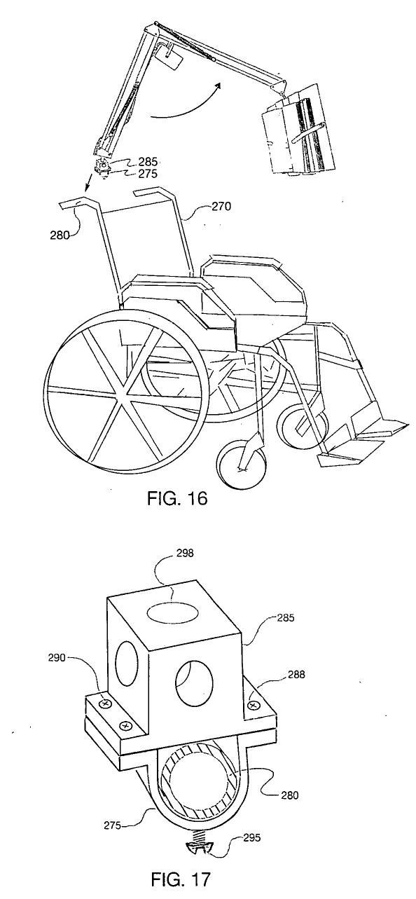

Turning now to FIGS. 16 and 17, the system can be attached to a wheelchair 270 by brackets 275, 285. The adapter bracket 275 secures around the wheelchair handle 280 and attaches to a mounting bracket 285 with screws 290. The mounting bracket 285 is provided with screw holes 288 through which screws 290 can pass to secure the mounting bracket to the adapter bracket 275. A lock screw 295 provides additional holding support. The mounting bracket 285 has a yoke 298 that accepts the shaft 82 of the arm 85 which connects the mounting bracket 285 to the rest of the system 10 and assures adequate guidance and support for the structure. The shaft 92 is capable of rotating through a 360 angle within the yoke 298.

Referring to FIG. 14, the mounting bracket 285 may be secured to a wall (not depicted), or a bed frame 300 as shown. Screws 290 secure the bracket 285 to the wall or bed frame 300 through screw holes 288. A clamp 305 can be used to further secure the bracket 285 to the bed frame 300.

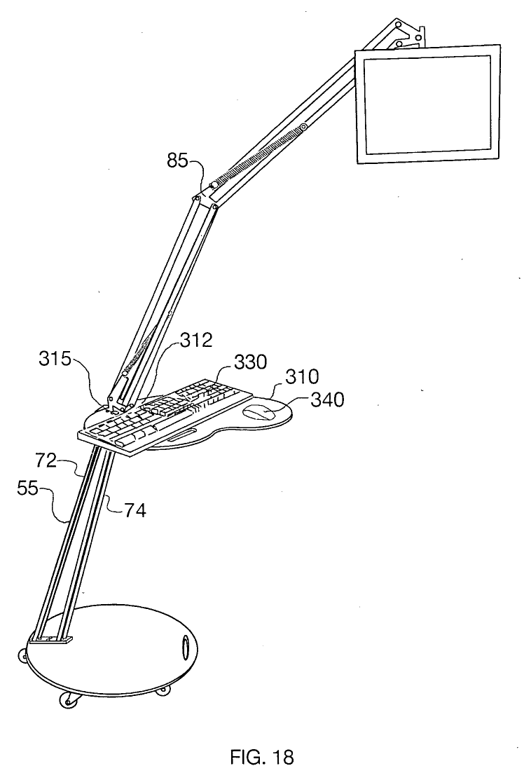

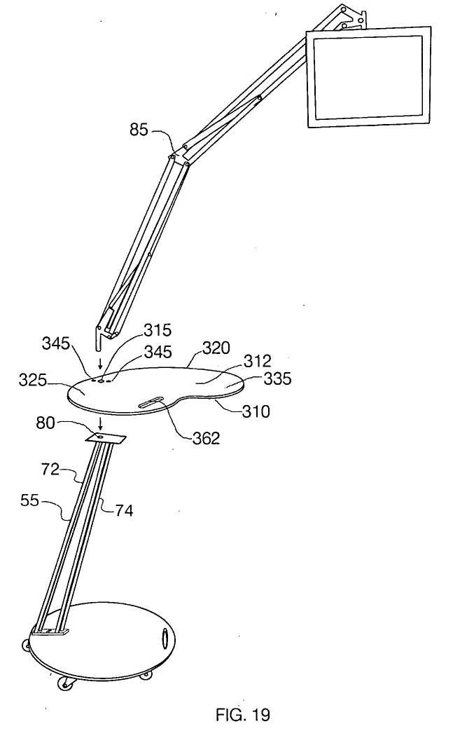

Referring now to FIGS. 18 and 19, the multimedia display system 10 may include a platform 310 connected to the system 10 between the stand 55 and the articulated arm 85. The platform 310 has a flat surface 312 and a passageway 315 so that the shaft 82 of the arm 85 may be placed through the passageway 315 and into the arm yolk 80, thus securing the platform 310 to system 10. The platform 310 may have a straight perimeter 320 or, as shown in the figures, a rounded perimeter 320. The platform has a first area 325 for placement of a wireless keyboard 330 and a second area 335 for a wireless mouse 340. In addition, the platform has a second passageway 345 through the platform 310 for allowing passage of the wire harness 265 through the platform 310. In addition, the platform 310 has a cutout 362 to serve as a grip.

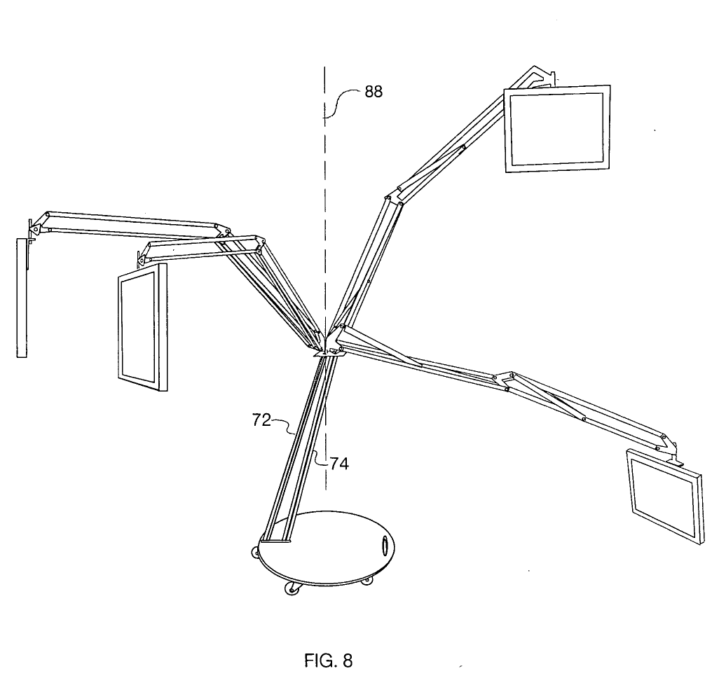

Referring to FIG. 7, the multimedia display system 10 has a mount 370 for holding a camera 375. The mount 370 may be connected to the attachment device 155 or the monitor 175.

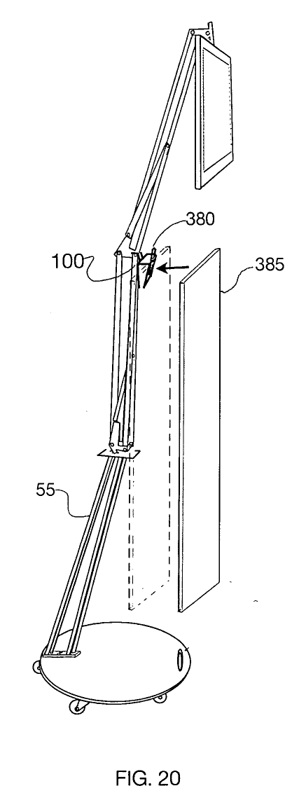

Turning now to FIG. 20, the multimedia display system 10 has a clip 380 for attaching visuals 385 such as posters, brochures, and papers. A visual 385 may be a picture, chart, or other presentation that appeals to the sense of sight, and may be used in promotion or for illustration or narration. The clip 380 is attached to the lower lever arm 100 of the articulated arm 85. Other means for attaching visuals may include Velcro, wire, tape, adhesive and other methods may be employed to attach visuals 385 to the system 10.

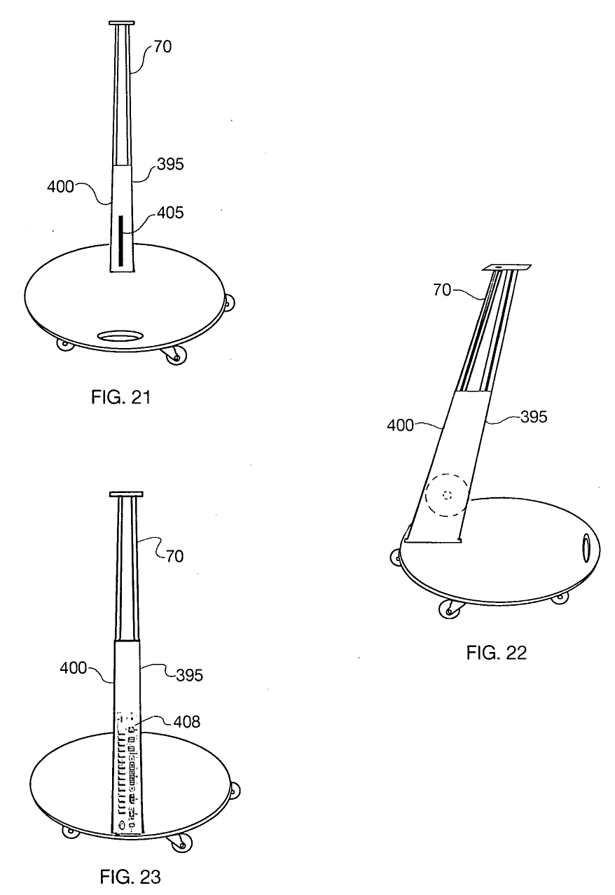

In another aspect, as shown in FIGS. 21-23, the multimedia display system 10 has a computer system 395 built into the stand 55. The four support members 70 define the corners of a trapezoidal shaped case 400 for housing the computer system 395. The computer 395 includes all the necessary components form a fully functional personal computer such as a DVD writer disc drive 405, a motherboard, RAM memory, a power supply, a CPU, receptacles 408 for various peripheral devices and a hard disc drive. The computer 395 may be connected to the monitor 175 or projector 250 for a fully functional, yet minimalist, kiosk for providing information, advertising or marketing to the public, or serve as a mobile work station in the workplace or home.

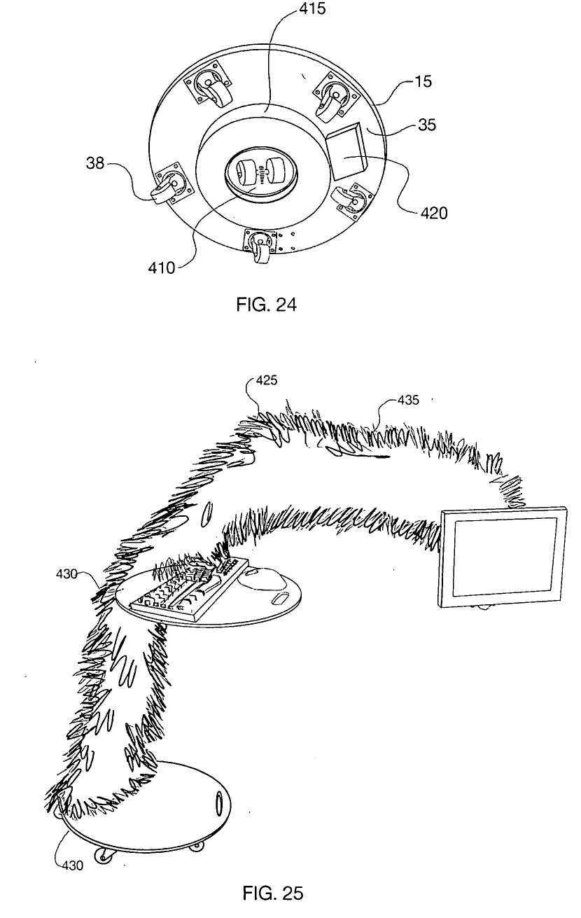

Adding to the autonomy of the system 10, as shown in FIG. 24, the display system 10 may have a rechargeable battery 410 connected to the underside 35 of the base 15. The system 10 may also have a motor 415 capable of being controlled remotely and attached to the underside 35 of the base 15 for providing locomotive power to the display system 10. The motor 415 may motorize a wheel 38 connected to the base. When attached to a plastic base 15, the motor 415 may also serve to increase the weight of the base 15 to balance and stabilize the system 10. The system 10 also has a global positioning system (GPS) 420 for sending and receiving coordinates to a remote location relating to the location of the display system 10. The GPS allows the system 10 to be located and is especially useful in large commercial environments, to assist a business or government enterprise in keeping track of its assets.

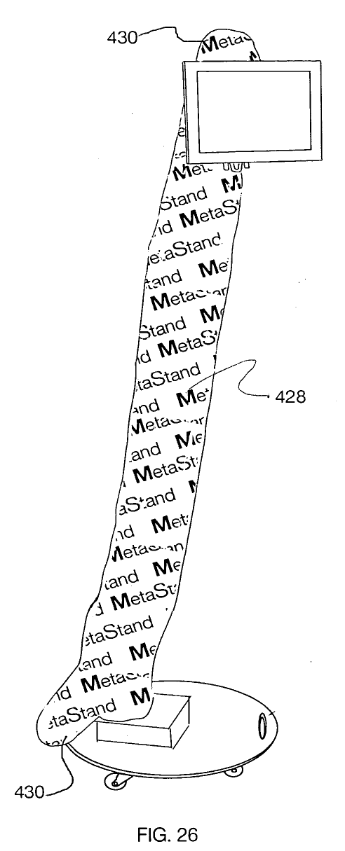

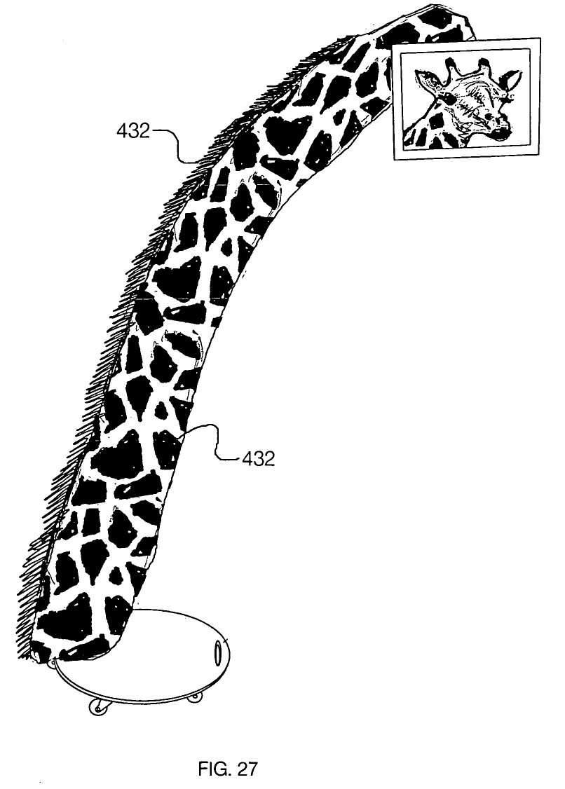

Turning now to FIGS. 25-27, the multimedia display system 10 includes a protective sleeve 425 with two opposite open ends 430 for envelopment of the articulated arm 85 and the stand 55. The sleeve 425, in addition to protecting the system from abrasions, scuffs, marks, and other damage, also functions as a display for various expressive structures and features. In one instance, the sleeve 425 has company trademarks and logos 428 printed thereon. In another instance, the sleeve 425 has the markings 432 of a giraffe printed thereon to give the sleeve the general appearance of the body of a giraffe so that when the monitor 175 displays the face of a giraffe, the system 10 expresses the appearance of a giraffe. Features of other animals may be indicated. In another instance, the sleeve 425 has flexible protrusions 435 comprising fuzz or fabric.

While the specification describes particular embodiments of the present invention, those of ordinary skill can devise variations of the present invention without departing from the inventive concept. Accordingly, it is not intended that the invention be limited, except as by the appended claims.

I claim:

1. A multimedia display system, comprising:
a base;
a rigid stand connected to the base and having at least one support member that forms an acute angle with the base;
an articulated arm operatively connected to the stand;
a platform positioned between the stand and the articulated arm, the platform having a first area and a substantially flat surface; and
an attachment device connected to the articulated arm.

2. The multimedia display system of claim 1, further comprising an arm yolk connected to a top of the stand, wherein the articulated arm is seated within the arm yolk and is rotatable within the arm yolk.

3. The multimedia display system of claim 1, wherein the platform has at least one passageway.

4. The multimedia display system of claim 1, further comprising a mount for holding a camera, the mount being connected to the attachment device.

5. The multimedia display system of claim 1, further including a view screen secured to the attachment device, the system also including a keyboard, and a computer.

6. The multimedia display system of claim 1, further comprising a wire harness for conducting wires, the harness located adjacent to the stand and the articulated arm.

7. The multimedia display system of claim 1, further comprising means for attaching visuals, the means for attaching visuals being connected to the articulated arm.

8. The multimedia display system of claim 1, wherein the stand defines a case that houses a computer system.

9. The multimedia display system of claim 1, further comprising a rechargeable battery connected to the base.

10. The multimedia display system of claim 1, further including at least two wheels connected to the base and a remote control motor attached to the base for providing locomotive power to the display system.

11. The multimedia display system of claim 1, further comprising a global positioning system for sending coordinates relating to the location of the display system.

12. The multimedia display system of claim 1, further comprising a sleeve.

13. The multimedia display system of claim 12, wherein the sleeve has animal skin indicia printed thereon to give the system the general appearance of the body of an animal.

14. The multimedia display system of claim 12, wherein the sleeve has trademark indicia printed thereon.

15. The multimedia display system of claim 12, wherein the sleeve has flexible protrusions.

16. The multimedia display system of claim 1, further comprising: a book support platform secured to the attachment device, the book support platform having two hook and loop straps and two clips.

17. The multimedia display system of claim 1, wherein the attachment device includes a planar surface with at least four passageways.

18. The multimedia display system of claim 1, wherein the base further comprises a cavity with a sealable opening.

19. A multimedia display system comprising:
a base;
a rigid stand connected to the base and having at least one support member that forms an acute angle with the base;
an articulated arm operatively connected to the stand; and
an attachment device connected to the articulated arm.

20. A multimedia display system for displaying visual or audio visual media comprising:
a base;
at least two wheels connected to the base;
a rigid stand connected to the base and having at least one support member that forms an acute angle with the base;
an arm yolk connected to a top of the stand;
an articulated arm operatively connected to the arm yolk and rotatable within the arm yolk; and
an attachment device connected to the articulated arm for attaching modules that display media, the attachment device including fasteners and a planar surface with at least four passageways for permitting the fasteners to connect to a module through the passageways in order to secure the module to the display system.
